(19) United States
(12) Patent Application Publication
(10) Pub. No.: US 2008/0112533 A1
(43) Pub. Date: May 15, 2008

(54) IMAGE INFORMATION RECORDING/READOUT METHOD AND APPARATUS

(75) Inventor: Masaharu OGAWA, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/937,549

(22) Filed: Nov. 9, 2007

(30) Foreign Application Priority Data
Nov. 9, 2006 (JP) 2006-303797

(51) Int. Cl. G03G 15/05

(52) U.S. Cl. 378/28

(57) ABSTRACT

In order to reduce and stabilize photovoltaic noise, dark latent image noise, and high voltage application history noise, a preliminary processing is performed regularly during an intermission between recordings of image information, in which voltage application for applying a voltage of predetermined magnitude and polarity between the electrode of the first electrode layer and the electrode of the second electrode layer for a predetermined time, and light irradiation for irradiating erasing light on the photoconductive layer with the first and second electrode layers being maintained at the same potential are performed.

### BACKGROUND OF THE INVENTION

1. Field of the Invention

The present invention relates to an image recoding/readout method and apparatus for recording image information in an electrostatic recorder as an electrostatic latent image, and reading out the recorded electrostatic latent image.

2. Description of the Related Art

In medical X-ray imaging and the like, an image recording/readout system that uses an X-ray sensitive photoconductor such as, for example, a selenium plate formed of a-Se (amorphous selenium) as an electrostatic recorder (photoreceptor, solid state radiation detector) in order to reduce radiation dose received by the subject and to improve diagnostic performance. In the system, recording radiation, such as X-ray representing radiation image information is irradiated on the electrostatic recorder to store latent image charges representing the radiation image information in the storage section of the electrostatic recorder, thereafter currents generated in the electrostatic recorder by scanning the recorder with readout light (readout electromagnetic wave), such as a laser beam, are detected through a plate electrode or comb electrode on each side of the electrostatic recorder, thereby the electrostatic latent image represented by the latent image charges, i.e., radiation image information is read out.

One of specific layer structures of such electrostatic recorder includes: a first conductor layer (recording light side electrode layer, the same applies hereinafter); a recording photoconductive layer; a trap layer as the storage section; a readout photoconductive layer; and a second conductor layer (readout light side electrode layer, the same applies hereinafter) as described, for example, in U.S. Pat. No. 4,535,468.

Another layer structure is proposed by the applicant of the present invention in U.S. Pat. No. 6,268,614. The structure includes the following layers stacked in the order listed below: a first conductor layer which is transparent to recording radiation; a recording photoconductive layer that shows conductivity when exposed to recording light; a charge transport layer that acts as substantially an insulator against charges having the same polarity as the charges charged on the first conductor layer and as substantially a conductor for the charges having the opposite polarity; a readout photoconductive layer that shows conductivity when exposed to readout light (readout electromagnetic wave); a second conductor layer which is transparent to readout light, with a storage section formed between the recording photoconductive layer and charge transport layer.

In such electrostatic recorder, a barrier electric field is formed at the interface between the second conductor layer, which is transparent to the readout light, and photoconductive layer formed of a-Se or the like. This causes currents to flow, even when the dose of recording light is in the range of 0 mR, by the irradiation of readout light, posing a problem of so-called photovoltaic noise.

Continued use of the electrostatic recorder causes the photovoltaic noise to show local dependency, which leads to a problem of artifact.

Further, a high resistance amorphous material (having a trap) is generally used for the photoconductive layer of the electrostatic recorder, but a direct charge injection occurs from the electrode to the photoconductive layer during the time period from the application of voltage (normally high voltage) between the electrodes at both ends to short-circuiting them. While some of the injected charges are trapped inside of the photoconductive layer or the interface between the photoconductive layer and the electrode, other charges are not trapped as space charges, causing dark currents to flow inside of the photoconductive layer as leakage currents. The dark current is stored in the storage section as a dark latent image which appears in a reproduced image as so-called dark latent image noise when a readout operation is performed. The dark current shows characteristic features that it has a large value just after the voltage is applied, then gradually decreasing with the time, and approaching to a constant leakage current value. That is, the dark current level immediately after voltage application is greater than the dark current level of stable leakage current state. This phenomenon is more significant for higher voltage, and sometimes it takes, for example, more than ten minutes to be stabilized to the leakage current level. Further, when the both electrodes are short-circuited to stop voltage application for a while, and then the voltage is applied to the electrodes again, the stabled dark current level returns to the original level immediately after the voltage application. Thus, the dark latent image caused by the high level dark current immediately after the voltage application is a large source of noise when a readout operation is performed. Still further, the amount of dark latent image changes with the time from the application of the voltage to the irradiation of the recording radiation and usage history, so that it is difficult to correct image data not to appear the dark latent image noise on the reproduced image.

Further, an electric field is formed at the interface between the photoconductive layer and electrode due to space charges generated by the application of recording voltage as describe above. In addition, as a result of short-circuiting of the electrodes prior to the readout operation, a new electric field is formed through voltage application (generally, high voltage) and short-circuiting, and light (readout light) is irradiated under the new electric field, which poses a problem of high voltage application history noise to be generated. The high voltage application history noise also changes with time and usage history, it is difficult to correct image data not to appear the high voltage application history noise on the reproduced image, like the dark latent image noise described above.

Further continued use of the electrostatic recorder causes the high voltage application history noise to show local dependency, like the photovoltaic noise, which leads to a problem of artifact.

For this reason, the applicant of the present invention has proposed performance of light irradiation, in U.S. Pat. No. 6,373,063, in which erasing light (pre-exposure light) is irradiated on the photoconductive layer with the electrodes of the first and second electrode layers being maintained at the same potential. This causes a light-induced fatigue state (trap storage state) is temporarily formed at the interface on which the erasing light is incident (electron/hole pair forming area). Thus, the photovoltaic noise that may possibly occur when the readout light is irradiated is decreased and stabilized by the light-induced fatigue state.

Further, the applicaint of the present invention has also proposed performance of voltage application in which a voltage of predetermined magnitude and polarity is applied between the electrodes for a predetermined time prior to performing the erasing light irradiation. This causes a space charge state that provides an apparently stable high resistant state to be formed inside of the photoconductive layer or at the interface between the photoconductive layer and the electrode. In addition, a less amount of dark latent image is stored in the storage section, which eliminates the possibility that high level dark latent image noise is generated immediately after the application of the recording voltage as before, and the dark latent image noise is decreased and stabilized.

It has been recognized, however, that the method described in U.S. Pat. No. 6,373,063 is unable to sufficiently reduce the photovoltaic noise, dark latent image noise, and high voltage application history noise, and image quality is degraded even if the voltage application and erasing light irradiation are performed in the case in which a recording of image information is performed after the voltage application and erasing light irradiation are performed, then the application of the voltage to the electrostatic recorder is stopped for a while, and a recording of image information is performed again.

The present invention has been developed in view of the circumstances described above, and it is an object of the present invention to provide an image information recording/readout method and apparatus for recording image information in an electrostatic recorder as an electrostatic latent image and reading out the recorded electrostatic latent image capable of reducing and stabilizing photovoltaic noise arising from the optical reading, dark latent image noise formed immediately after the application of voltage, and high voltage application history noise arising from the application of recording voltage and short-circuiting.

### SUMMARY OF THE INVENTION

The image information recording/readout method of the present invention is a method for recording and reading out image information using an electrostatic recorder including the following stacked in the order listed below: a first electrode layer; a photoconductive layer that shows conductivity by receiving a recording electromagnetic wave representing image information; and a second electrode layer, with a storage section formed between the first and second electrode layers for storing an amount of charges in proportion to an amount of energy of the electromagnetic wave as latent image charges, in which the image information is recorded in the storage section as an electrostatic latent image when the recording electromagnetic wave is irradiated on the first electrode layer with a recording voltage being applied between the electrode of the first electrode layer and the electrode of the second electrode layer, and image information proportional to the latent image charges is read out with the first and second electrode layers being maintained at the same potential,

wherein a preliminary processing is performed regularly during an intermission between recordings of image information, in which voltage application for applying a voltage of predetermined magnitude and polarity between the electrode of the first electrode layer and the electrode of the second electrode layer for a predetermined time, and light irradiation for irradiating erasing light on the photoconductive layer with the first and second electrode layers being maintained at the same potential are performed.

The electrostatic recorder used in the present invention may be any optical readout type recorder as long as it includes a first electrode layer, a photoconductive layer, and a second electrode layer stacked in this order, with a storage section formed between the first and second electrode layers. It may be a recorder further including another layer or microscopic conductive member (microplate) for forming the storage section as described, for example, in U.S. Pat. No. 4,535,468 or U.S. Pat. No. 6,268,614.

As for the “recording electromagnetic wave representing image information”, for example, transmitted radiation representing transmitted radiation image information obtained by irradiating radiation, such as X-rays, to a subject, light emitted through excitation by the radiation, such as fluorescence representing the transmitted radiation image information obtained by irradiating the transmitted radiation onto a phosphor (scintillator), or general visible light representing image information may be used.

The referent of “with the first and second electrode layers being maintained at the same potential” is not limited to the case in which the same potential is maintained by directly connecting the electrodes of both electrode layers, but may include the case in which the electrodes of both electrode layers have substantially the same potential, although there is a slight potential difference between them, as, for example, in the case in which they are connected through the imaginary short of the operational amplifier or a resistor.

Preferably, the light for the erasing light irradiation has a high intensity to effectively cause light-induced fatigue. On the other hand, the erasing light is not required to be erradiated for a long time (e.g., 10 seconds) and a relatively short time (e.g., approximately 1 millisecond to 1 second) is sufficient.

Further, the voltage application is not required to be performed for a long time (e.g., 10 seconds) and a relatively short time (e.g., less than or equal to 1 second) is sufficient.

When irradiating the erasing light on the photoconductive layer, it is desirable that the erasing light is irradiated from the electrode layer side where readout light is irradiated (normally, second electrode layer), and the erasing light has substantially uniform intensity over the entire surface of the electrostatic recorder.

The readout light is a readout electromagnetic wave, and not limited to visible light. The photoconductive layer that shows conductivity by receiving readout light may be a photoconductive layer used also as the photoconductive layer that shows conductivity by receiving a recording electromagnetic wave, or a dedicated photoconductive layer.

The relationship between the time interval of the preliminary processing and sensitivity variation of the electrostatic recorder will now be described. FIG. 3 illustrates graphs showing the relationship between the time interval of the preliminary processing and sensitivity variation of the electrostatic recorder. The vertical axis of the graph represents the sensitivity (mR), and the horizontal axis represents the number of times of preliminary processing. Graphs A, B, C, and D represent data measured at different places of the electrostatic recorder. The time interval of the preliminary processing is 22 seconds, except that intermissions of 1 minute, 5 minutes, 10 minutes, and 20 minutes are provided between the 2nd and 3rd times, between 12th and 13th times, between 22nd and 23rd times, and between 32nd and 33rd times respectively.

As illustrated in FIG. 3, the sensitivity curve changes only little when an intermission of 1 minute is provided (between 2nd and 3rd times), whereas it changes significantly when an intermission of 5 minutes or more is provided (between 12th and 13th times, between 22nd and 23rd times, and between 32nd and 33rd times). Further, the sensitivity curve remains substantially constant when the preliminary processing is performed regularly. The graphs A, B, C, and D show sensitivity characteristics substantially identical to each other, so that it is clear that such sensitivity characteristics show no local dependency, and identical throughout the electrostatic recorder.

As described above, when the preliminary processing is performed at least once in every 60 seconds or less, advantageous effects of reducing and stabilizing photovoltaic noise, dark latent image noise, and high voltage application history noise may be obtained. It is preferable, however, that the preliminary processing be performed once in every 30 seconds or less, and more preferably once in every 10 seconds or less in order to obtain more significant noise reduction and stabilization effects.

The image information recording/readout apparatus of the present invention is an apparatus for recording and reading out image information using an electrostatic recorder including the following stacked in the order listed below: a first electrode layer; a photoconductive layer that shows conductivity by receiving a recording electromagnetic wave representing image information; and a second electrode layer, with a storage section formed between the first and second electrode layers for storing an amount of charges in proportion to an amount of energy of the electromagnetic wave as latent image charges, in which the image information is recorded in the storage section as an electrostatic latent image when the recording electromagnetic wave is irradiated on the first electrode layer with a recording voltage being applied between the electrode of the first electrode layer and the electrode of the second electrode layer, and image information proportional to the latent image charges is read out with the first and second electrode layers being maintained at the same potential, the apparatus including:

a voltage application means for applying a predetermined voltage between the electrode of the first electrode layer and the electrode of the second electrode layer;

an erasing light irradiation means for irradiating erasing light on the photoconductive layer; and
a control means for controlling the voltage application means and the erasing light irradiation means such that a preliminary processing is performed regularly during an intermission between recordings of image information, in which voltage application for applying a voltage of predetermined magnitude and polarity between the electrode of the first electrode layer and the electrode of the second electrode layer for a predetermined time, and light irradiation for irradiating erasing light on the photoconductive layer with the first and second electrode layers being maintained at the same potential are performed.

In the image information recording/readout apparatus described above, if the control means is a means for causing the preliminary processing to be performed once in every 60 seconds or less, advantageous effects of reducing and stabilizing photovoltaic noise, dark latent image noise, and high voltage application history noise may be obtained. Here, if the control means is a means for causing the preliminary processing to be performed preferably once in every 30 seconds or less, and more preferably once in every 10 seconds or less, more significant noise reduction and stabilization effects may be obtained.

According to the image information recording/readout method and apparatus of the present invention, preliminary processing is performed regularly during an intermission between recordings of image information, in which voltage application for applying a voltage of predetermined magnitude and polarity between the electrode of the first electrode layer and the electrode of the second electrode layer for a predetermined time, and light irradiation for irradiating erasing light on the photoconductive layer with the first and second electrode layers being maintained at the same potential are performed. This allows the photovoltaic noise, dark latent image noise, and high voltage application history noise in the electrostatic recorder to be constantly maintained in reduced and stabilized state, so that even if an image recording is performed after a long intermission, a high quality image may be recorded.

In the image recording/readout method and apparatus, if the preliminary processing is performed at least once in every 60 seconds or less, advantageous effects of reducing and stabilizing photovoltaic noise, dark latent image noise, and high voltage application history noise may be obtained. It is preferable, however, that the preliminary processing be performed once in every 30 seconds or less, and more preferably once in every 10 seconds or less in order to obtain more significant noise reduction and stabilization effects.

### BRIEF DESCRIPTION OF THE DRAWINGS

FIG. 1 is a schematic view of a radiation image recording/readout apparatus to which the image information recording/readout method and apparatus of the present invention are applied.

FIG. 2 is a timing chart illustrating the operation of the radiation image recording/readout apparatus to which the image information recording/readout method and apparatus of the present invention are applied.

FIG. 3 illustrates graphs showing the relationship between the time interval of preliminary processing and sensitivity variation of the electrostatic recorder.

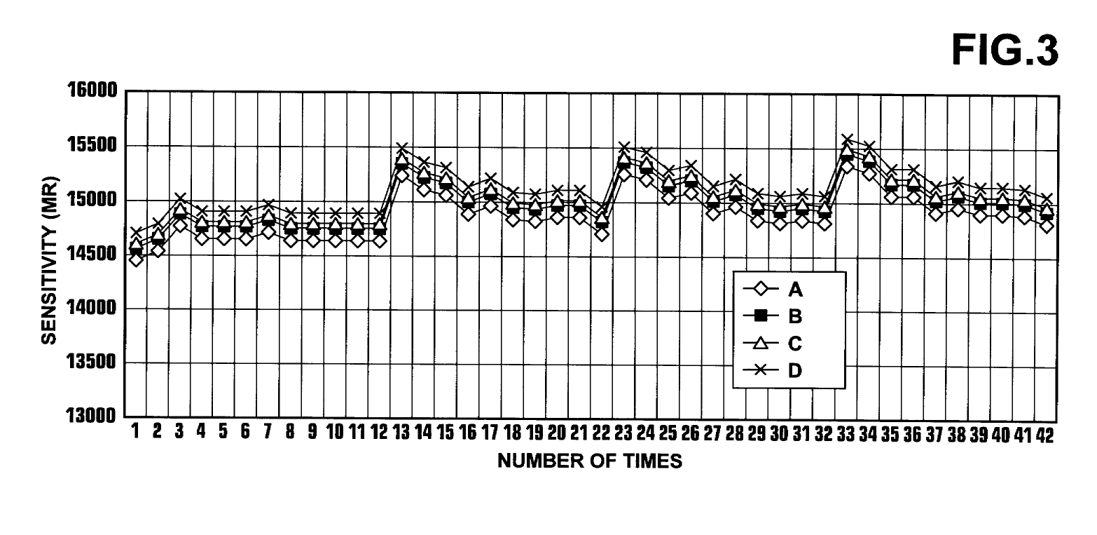

### DESCRIPTION OF THE PREFERRED EMBODIMENTS

Hereinafter, an embodiment of the present invention will be described in detail with reference to the accompanying drawings.

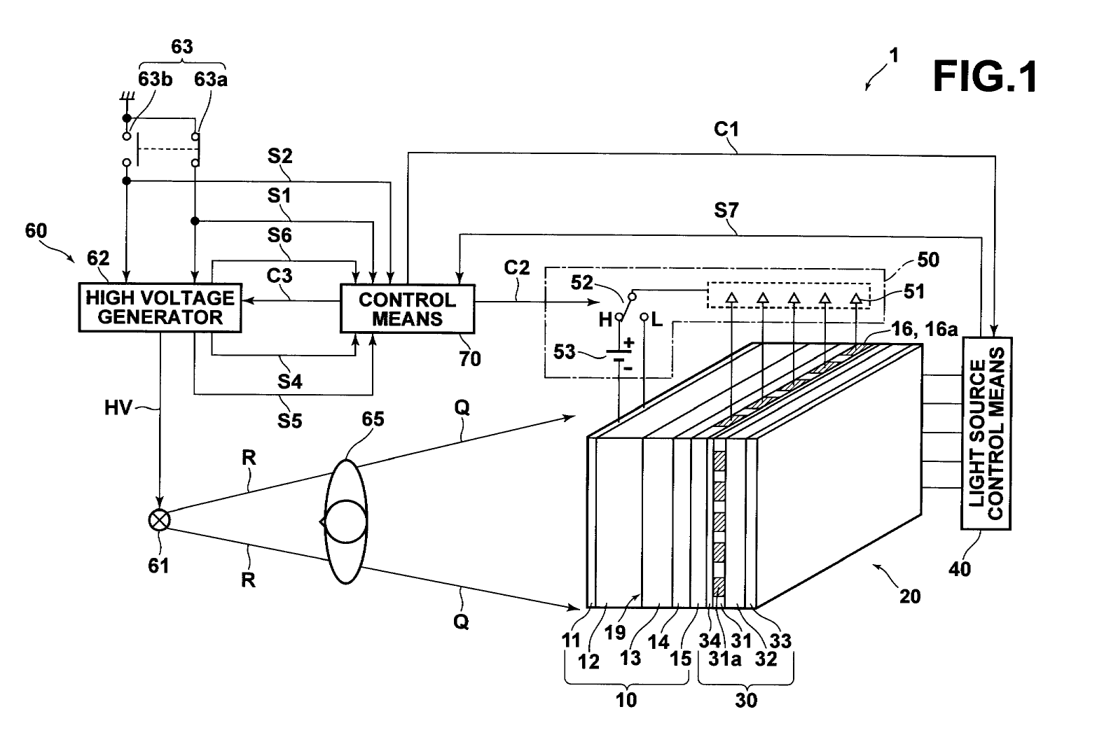

FIG. 1 is a schematic view of a radiation image recording/readout apparatus to which the image information recording/readout method and apparatus of the present invention are applied.

As illustrated in FIG. 1, the radiation image recording/readout apparatus 1 includes: a solid state radiation detector (also simply referred to as “detector”) 10, as an electrostatic recorder; a planar light source 30 stacked on the detector 10; a readout unit 20 including a light source control means 40 for controlling the planar light source 30 and a current detection circuit 50 for reading out charges from the detector 10; a radiation irradiation unit 60; and a control means 70 connected to the current detection circuit 50 and radiation irradiation unit 60.

The detector 10 generates charges in a recording photoconductive layer 12 when recording radiation (e.g., X-ray) transmitted through a subject, serving as an electromagnetic wave representing image information, is irradiated on a first electrode layer (conductor layer) 11, which are stored in a storage section 19 at the interface between the recording photoconductive layer 12 and a charge transport layer 13 as latent image charges, and generates charges in a readout photoconductive layer 14 when a second electrode layer (conductor layer) 15 is scanned with readout light (readout electromagnetic wave), which are combined with the latent image charges and currents are generated in proportion to the amount of latent image charges. The second electrode layer 15, serving as the readout electrode layer, includes multitudes of line electrodes (shaded areas in FIG. 1) disposed in stripes. Hereinafter, the electrode of the second electrode layer is referred to as “stripe electrode”, and each line electrode is referred to as “element 16a”.

The recording photoconductive layer 12, charge transport layer 13, and readout photoconductive layer 14 are made of an amorphous state material based on a-Se.

The planar light source 30 is an EL phosphor including a conductive layer 31, an EL layer 32, and a conductive layer 33, and stacked on the detector 10 in the manner as described above. An insulation layer 34 is provided between the stripe electrode 16 of the detector 10 and the conductive layer 31. The conductive layer 31 includes multitudes of elements 31a (shaded areas in FIG. 1) disposed in stripes. Each element 31a is arranged to intersect (substantially orthogonal) with each element 16a of the stripe electrode 16 of the detector 10. This creates multitudes of line light source of elements 31a disposed two-dimensionally. Each element 31a is connected to the light source control means 40.

As for the EL layer 32, a material that emits EL light having a wavelength around 470 nm is used in consideration of the matching with a-Se, the major component of the readout photoconductive layer 14 of the detector 10.

The light source control means 40 is a means for applying a predetermined voltage between the element 31a and the opposite conductive layer 33. It applies the voltage to the individual elements 31a when a readout operation is performed, and to a plurality or all of the elements 31a when irradiating erasing light. For example, if a predetermined DC voltage is applied between each of the elements 31a and conductive layer 33 by sequentially switching the elements 31a, El light is emitted from the El layer sandwiched between the element 31a and conductive layer 33, and the EL light transmitted through the element 31a is used as line readout light (line light). That is, the planar light source 30 is equivalent to multitudes of microscopic line light sources disposed two dimensionally. Accordingly, the entire surface of the stripe electrode 16 may be electrically scanned with the line light by sequentially switching the elements 31a from one end of the stripe electrode 16 in the longitudinal direction to the other end and emitting EL light. Here, the longitudinal direction of the element 16a corresponds to the sub-scanning direction, and the direction in which the line light is extending corresponds to the main scanning direction.

In the mean time, if the voltage is applied to a plurality or all of the elements 31a at the same time, EL light is emitted across the entire stripe electrode 16 from the EL layer 32 substantially uniformly, which is used as erasing light. That is, the planar light source 30 functions not only as the readout light source but also as a light source for erasing light to be described later. The planar light source 30 and light source control means 40 are formed to function as the erasing light irradiation means of the present invention.

The light source control means 40 is constructed to receive a control signal C1, and if the control signal C1 is L (low) the planar light source 30 is set to erasing light mode in which EL light is emitted as erasing light, and if the control signal C1 is H (high), the planar light source 30 is set to readout light mode in which EL light is emitted as readout light. When the control signal C1 is in high impedance, EL light is not emitted from the planar light source 30.

The current detection circuit 50 includes multitudes of current detection amplifiers 51 connected to inverting input terminals, each for each element 16a of the stripe electrode 16. The first electrode layer 11 of the detector 10 is connected to one input of the switch 52 and to the negative terminal of the power source 53. The positive terminal of the power source 53 is connected to the other input of the switch 52. The switch 52 and power source 53 constitute the voltage application means of the present invention.

The output of the switch 52 is commonly connected to non-inverting input terminals of not shown operational amplifiers, each constituting each current detection amplifier 51. When line light, as the readout light, is irradiated to the side of stripe electrode 16 (scan exposure) from the planar light source 30, the currents flowing through the respective elements 16a are detected by the respective current detection amplifiers connected thereto simultaneously (in parallel).

Detailed description of the current detection amplifier is not provided here, since it is not related to the gist of the present invention, but various known structures may be used. It should be appreciated the connection aspect of the current detection amplifiers 51 to the switch 52, power supply 53, and the respective elements 16a differs from that described above depending on the configuration of the current detection amplifiers 51.

The radiation irradiation unit 60 includes: a radiation source 61 for emitting radiation R; a high voltage generator 62 for generating power for driving the radiation source 61; and a switch 63 for controlling imaging, which is connected to the high voltage generator 62. The switch 63 is a two-step switch including switches 63a and 63b. The switch 63 is structured such that the switch 63b is not switched on unless the switch 63a is switched on.

In order to cause the operation of the present invention to be performed at predetermined timings, signals S1, S2 from the switches 63a, 63b, a standby signal S4 from the high voltage generator 62, an end of irradiation signal S5 indicating the end of irradiation of the recording radiation and a signal S6 indicating the irradiation time set for the recording radiation, and an end of irradiation signal S7 from the light source control means 40 indicating the end of irradiation of the erasing light are inputted to the control means 70. The control means 70 outputs the control signal C1 to the light source control means 40, a control signal C2 to the switch 52, and a control signal C3 to the high voltage generator 62.

If the control signal C2 is H, the switch 52 is switched to the power source 53, and a DC voltage is applied to the detector 10 (more specifically, between the electrode of the first electrode layer 11 and stripe electrode 16) from the power source 53. On the other hand, if the control signal C2 is L, the switch 52 is switched to the first electrode layer 11, and the electrode of the first electrode layer 11 and the stripe electrode are substantially short-circuited through the imaginary short of the operational amplifier (not shown) constituting the current detection amplifier 51, to cause both electrodes to have the same potential. When the control signal C2 is in high impedance, the switch 52 is set to the midpoint, thereby the positive terminal of the power supply 53 is made in a floating state, so that neither the voltage is applied to the detector 10 nor the both electrodes are set at the same potential. When a H signal, as the control signal C3, is inputted, the high voltage generator 62 supplies a high voltage HV to the radiation source 61 and causes the radiation source 61 to generate the radiation R.

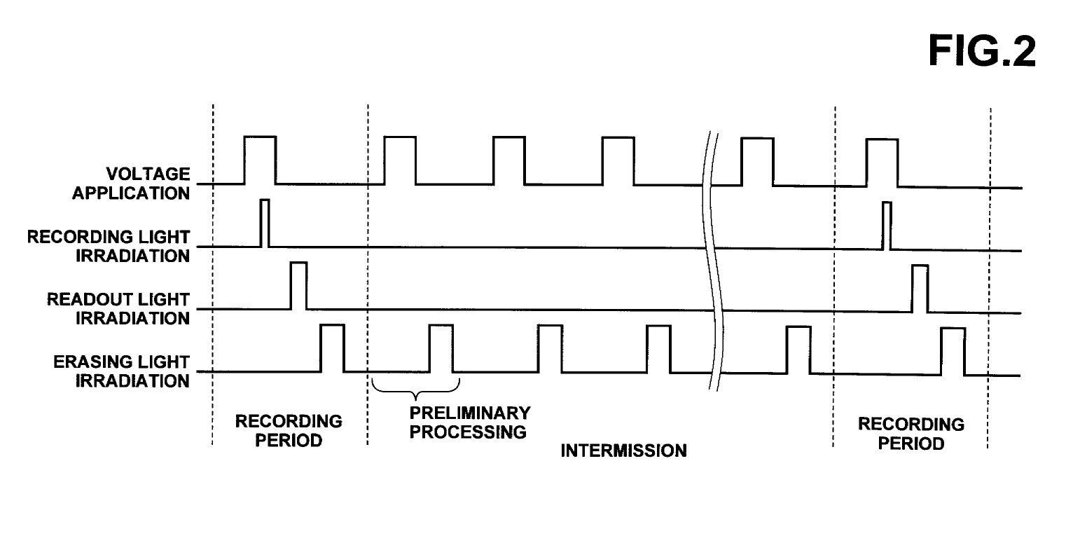

The operation of the radiation image recording/readout apparatus 1 constructed in the manner as described above will now be described. FIG. 2 is a timing chart illustrating the operation of the apparatus 1. In the timing chart of FIG. 2, a high-level period indicates an active period in which a voltage is applied to the detector or light (erasing light, recording radiation, or readout light) is irradiated on the detector, while a low-level period (reference level period) indicates an inactive period which is contrary to the active period.

The sequence at the time of recording will be described first. An electrostatic latent image is recorded in the detector 10 by irradiating recording radiation Q on the first electrode layer 11 with a recording voltage being applied between the electrode of the first electrode layer 11 and stripe electrode 16. More specifically, a DC voltage of predetermined magnitude, as the recording voltage, is applied between the electrode of the first electrode layer 11 and stripe electrode 16 from the power source 53 by switching the switch 52 to the power source 53 to cause the both electrodes to be charged, so that the charges to be generated in the recording photoconductive layer 12 of the detector 10 are stored in the storage section 19.

After the recording voltage is applied, the high voltage HV is supplied to the radiation source 61 from the high voltage generator 62 to cause the radiation source 61 to emit the radiation R. The radiation R is irradiated to a subject 65 and recording radiation Q transmitted through the subject 65 and representing radiation image information of the subject 65 is irradiated on the detector 10 for a predetermined time. Then, positive-negative charge pairs are generated in the recording photoconductive layer 12 of the detector 10, and negative charges of the charge pairs are collected to each element 16a of the stripe electrode 16 along a predetermined electric field distribution, and stored in the storage section 19, which is the interface between the recording photoconductive layer 12 and charge transport layer 13, as latent image charges. The amount of the latent image charges is substantially proportional to the irradiated radiation dose, so that the latent image charges represent an electrostatic latent image. In the mean time, positive charges generated in the recording photoconductive layer 12 are attracted to the first electrode layer 11, and there recombine with negative charges injected from the power supply 53 and disappear.

Next, when reading out the electrostatic latent image from the detector 10, the control signal C1 is set to H (readout light mode), and the switch 52 is connected to the first electrode layer 11 of the detector 10. Then, a predetermined DC voltage is applied between the respective elements 31a and the conductive layer 33 while sequentially switching the elements 31a by the light source controlling means 40, and the entire surface of the detector 10 is electrically scanned with the line light emitted from the EL layer 32.

By the scanning of the detector 10 with the line light, positive-negative charge pairs are generated in the photoconductive layer 14 corresponding to the sub-scanning position onto which the line light is irradiated. Positive charges of the charge pairs are attracted by the negative charges (latent image charges) stored in the storage section 19 and move rapidly through the charge transport layer 13. Then, in the storage section 19, the positive charges recombine with the latent image charges and disappear. In the mean time, negative charges generated in the photoconductive layer 14 recombine with positive charges injected from the power source 53 to the stripe electrode 16 and disappear. In this way, the negative charges stored in the storage section 19 of the detector 10 disappear by the charge recombination, and currents arising from the movement of the charges during the charge recombination are generated in the detector 10. These currents are detection by each amplifier 51 connected to each element 16a at the same time. The currents flowing in the detector 10 in the readout operation correspond to the latent image charges, that is, the electrostatic latent image. Therefore, the electrostatic latent image may be read out by detecting these currents, that is, image signals representing the electrostatic latent image may be obtained.

Next, the control signal C2 inputted to the switch 52 is set to L by the control section 70. This causes the switch 52 to be switched to the first electrode layer 11, and the electrode of the first electrode layer 11 and the stripe electrode 16 are substantially short-circuited so as to have the same potential. Then, the control signal C1 inputted to the light source control means 40 is set to L (erasing light mode) to cause the planar light source 30 to emit EL light, as erasing light, thereby erasing light irradiation is performed, in which the erasing light is irradiated on the readout photoconductive layer 14.

Next, in order to terminate the erasing light irradiation, the control signal C1 inputted to the light source control means 40 is set to high impedance to cause the planar light source 30 to terminate the emission of the EL light.

The operation of the apparatus at the time of readout operation is completed through the sequence described above.

As illustrated in FIG. 2, the present invention reduces and stabilizes photovoltaic noise, dark latent image noise, and high voltage application history noise by repeating preliminary processing in which the voltage application and erasing light irradiation are performed during an intermission of recording, that is, a period from the end of the aforementioned sequence to the beginning of the sequence of the next recording operation.

The sequence during the intermission period of recording will now be described.

First, the control means 70 causes voltage application to be performed, in which a voltage of predetermined magnitude and polarity is applied between the electrode of the first electrode layer 11 and the stripe electrode 16 for a predetermined time. More specifically, the switch 52 is switched to the power source 53, and the voltage is applied from the power source 53 between the electrode of the first electrode layer 11 and the stripe electrode 16 for a predetermined time.

FIG. 1 illustrates that a voltage having the same magnitude and polarity as the recording voltage is applied, but the magnitude and polarity of the voltage may be changed to differ from those of the recording voltage by adapting the power source 53 to have capabilities for changing the voltage value and polarity.

Next, the control signal C2 inputted to the switch 52 is set to L by the control section 70. This causes the switch 52 to be switched to the first electrode layer 11, and the electrode of the first electrode layer 11 and the stripe electrode 16 are substantially short-circuited so as to have the same potential. Then, the control signal C1 inputted to the light source control means 40 is set to L (erasing light mode) to cause the planar light source 30 to emit EL light, as erasing light, thereby erasing light irradiation is performed, in which the erasing light is irradiated on the readout photoconductive layer 14.

Next, in order to terminate the erasing light irradiation, the control signal C1 inputted to the light source control means 40 is set to high impedance to cause the planar light source 30 to terminate the emission of the EL light.

The control means 70 controls each component of the apparatus 1 such that the preliminary processing of aforementioned sequence is performed once in every 10 seconds.

It is noted that advantageous effects of reducing and stabilizing photovoltaic noise, dark latent image noise, and high voltage application history noise may be obtained by performing the preliminary processing at least once in every 60 seconds or less. It is preferable, however, that the preliminary processing be performed once in every 30 seconds or less, and more preferably once in every 10 seconds or less in order to obtain more significant noise reduction and stabilization effects.

So far the radiation image recording/readout apparatus to which the image information recording/readout method and apparatus of the present invention are applied has been described. But, the present invention is not limited to the embodiment described above, and the structure of various means, such as the structure of the electrostatic recorder (solid state radiation detector) and the structure of the erasing light irradiation means may be changed as appropriate. Further, the sequence during recording or intermission period may also be changed as appropriate.

For example, the electrostatic recorder may be any optical readout type recorder as long as it includes a first electrode layer, a photoconductive layer, and a second electrode layer stacked in this order, with a storage section formed between the first and second electrode layers. It may further include another layer or microscopic conductive member (microplate) for forming the storage section.

Further, the structure of the readout light irradiation means and erasing light irradiation means is not limited to that constituted by the planar light source 30 and light source control means 40. The readout light irradiation means may be any means as long as it is capable of moving the position of beam light or line light relative to the electrostatic recorder. For example, it may be a separate means from the erasing light irradiation means. Further, it is not limited to the electrical scanning, and it may be a structure that relatively moves the light source and electrostatic recorder.

Still further, the preliminary processing is not limited to the embodiment in which the voltage application is performed first and then the erasing light irradiation is performed as described above. For example, it may be embodied in any manner as long as both the voltage application and erasing light irradiation are performed, such as that in which light irradiation (pre-exposure), voltage application, and erasing light irradiation (post-exposure) are performed in this order.

What is claimed is:

1. An image information recording/readout method for recording and reading out image information using an electrostatic recorder including the following stacked in the order listed below: a first electrode layer; a photoconductive layer that shows conductivity by receiving a recording electromagnetic wave representing image information; and a second electrode layer, with a storage section formed between the first and second electrode layers for storing an amount of charges in proportion to an amount of energy of the electromagnetic wave as latent image charges, in which the image information is recorded in the storage section as an electrostatic latent image when the recording electromagnetic wave is irradiated on the first electrode layer with a recording voltage being applied between the electrode of the first electrode layer and the electrode of the second electrode layer, and image information proportional to the latent image charges is read out with the first and second electrode layers being maintained at the same potential,
wherein a preliminary processing is performed regularly during an intermission between recordings of image information, in which voltage application for applying a voltage of predetermined magnitude and polarity between the electrode of the first electrode layer and the electrode of the second electrode layer for a predetermined time, and light irradiation for irradiating erasing light on the photoconductive layer with the first and second electrode layers being maintained at the same potential are performed.

2. The image information recording/readout method of claim 1, wherein the preliminary processing is performed once in every 60 seconds or less.

3. The image information recording/readout method of claim 1, wherein the preliminary processing is performed once in every 30 seconds or less.

4. The image information recording/readout method of claim 1, wherein the preliminary processing is performed once in every 10 seconds or less.

5. An image information recording/readout apparatus for recording and reading out image information using an electrostatic recorder including the following stacked in the order listed below: a first electrode layer; a photoconductive layer that shows conductivity by receiving a recording electromagnetic wave representing image information; and a second electrode layer, with a storage section formed between the first and second electrode layers for storing an amount of charges in proportion to an amount of energy of the electromagnetic wave as latent image charges, in which the image information is recorded in the storage section as an electrostatic latent image when the recording electromagnetic wave is irradiated on the first electrode layer with a recording voltage being applied between the electrode of the first electrode layer and the electrode of the second electrode layer, and image information proportional to the latent image charges is read out with the first and second electrode layers being maintained at the same potential, the apparatus comprising:
a voltage application means for applying a predetermined voltage between the electrode of the first electrode layer and the electrode of the second electrode layer;
an erasing light irradiation means for irradiating erasing light on the photoconductive layer; and
a control means for controlling the voltage application means and the erasing light irradiation means such that a preliminary processing is performed regularly during an intermission between recordings of image information, in which voltage application for applying a voltage of predetermined magnitude and polarity between the electrode of the first electrode layer and the electrode of the second electrode layer for a predetermined time, and light irradiation for irradiating erasing light on the photoconductive layer with the first and second electrode layers being maintained at the same potential are performed.

6. The image information recording/readout apparatus of claim 5, wherein the control means is a means for causing the preliminary processing to be performed once in every 60 seconds or less.

7. The image information recording/readout apparatus of claim 5, wherein the control means is a means for causing the preliminary processing to be performed once in every 30 seconds or less.

8. The image information recording/readout apparatus of claim 5, wherein the control means is a means for causing the preliminary processing to be performed once in every 10 seconds or less.
